(19) United States
(12) Patent Application Publication
(10) Pub. No.: US 2018/0146760 A1
(43) Pub. Date: May 31, 2018

(54) A PROCESS FOR PRODUCING A HIGH-HEAT DELIVERY DEVICE OBTAINING OR CONSISTING OF A POLYMER COMPOSITION COMPRISING A FRAGRANCE, OR A PART THEREOF

(71) Applicant: DSM IP ASSETS B.V., Heerlen (NL)

(72) Inventor: Katrina TOMIC, Echt (NL)

(21) Appl. No.: 15/570,858

(22) PCT Filed: May 3, 2016
(86) PCT No.: PCT/EP2016/059845

§ 371 Date: Oct. 31, 2017

(30) Foreign Application Priority Data
May 8, 2015 (EP) 15166885.2

(51) Int. Cl. A45D 1/00; C11B 9/00; C08G 63/19; B29C 45/00; A45D 34/02; A45D 2/00; B29K 67/00; B29L 31/18; B29K 21/00

(52) U.S. Cl. CPC A45D 1/00; C11B 9/00; C08G 63/19; B29C 45/0001; B29K 2021/003; A45D 34/02; A45D 2/001; B29K 2067/003; B29L 2031/18; A45D 2001/006

(57) ABSTRACT

A process for producing a heat delivery device containing or consisting of a polymer composition comprising a fragrance or part thereof comprising the steps of: a) producing a first polymer composition, by feeding a thermoplastic polyester, optionally a first thermoplastic copolyester elastomer and optionally further components of the composition to an extruder, melting and mixing the components, b) cooling down the first polymer composition and c) feeding the first polymer composition and a master batch comprising a second thermoplastic copolyester elastomer and the fragrance to an injection molding machine, melting and mixing the first polymer composition and the master batch in the injection molding machine to obtain the second polymer composition and injection molding of the so obtained molten second polymer composition into the mold of the high-heat delivery device or the part thereof.

The invention relates to a process for producing a high-heat delivery device containing or consisting of a polymer composition comprising a fragrance, or a part thereof.

It is desired to add a fragrance to hair, while styling the hair with a hair styling apparatus device, such as a hair straightener or a hair curler. Different systems for providing such a fragrance are known. One such a system is a hair styling apparatus comprising a high-heat delivery device consisting of, or comprising at least one part of a polymer composition that comprises the fragrance. The high-heat delivery device is heated, normally by a heating element, such as for example heating plates, to a temperature of about 150° C. or even about 200° C. and brought in contact with the hair, often by applying a pressure to the hair. In this way the hair is styled, and while styling the hair, the fragrance is released.

This operation is critical, since it is carried out at high temperature, in a short period of time.

The high-heat delivery device or the part is described in WO2015/028632. It will normally be produced by a process comprising the steps:

a) melting and mixing the polymer composition without the fragrance in an extruder and injecting the fragrance in the melting zone of the extruder, so obtaining the composition of the part,
b) cooling down and granulating the composition and
c) injection molding of the high-heat-delivery device or the part thereof from the composition.

A disadvantage of the known high-heat delivery devise or part thereof is that the hair fragrance evaporates in a short time, when it is used to style the hair. Because of this it is only possible to use the high heat delivery device for providing the fragrance to the hair only a few times. Another problem is that the quality of the fragrance is affected, so that the smell of the fragrance losses its attractiveness.

Object of the invention is to provide a high-heat delivery device for a hear styling apparatus or a part thereof, that does not have this problem. Surprisingly this object has been obtained by providing a process for producing the heat delivery device containing or consisting of a polymer composition comprising a fragrance or part thereof comprising the steps:

a) producing a first polymer composition, by feeding a thermoplastic polyester, optionally a first thermoplastic copolyester elastomer and optionally further components of the composition to an extruder, melting and mixing the components of the polymer composition,
b) cooling down the first polymer composition and
c) feeding the first polymer composition and a master batch comprising a second thermoplastic copolyester elastomer and the fragrance to an injection molding machine, melting and mixing the first polymer composition and the master batch in the injection molding machine to obtain the second polymer composition and injection molding of the so obtained molten second polymer composition into the mold of the high-heat delivery device or the part thereof.

Surprisingly a high-heat delivery device is obtained that even after being repeatedly used, still releases the fragrance, when used again. A further advantage is that at room temperature no or only a very limited amount of fragrance is released, so that no or a very limited amount of fragrance is lost during transportation and storage of the parts after their fabrication process, but also at home, for example once being installed at a hair styling device by the customer. Still a further advantage is that if an oil is used in the composition, the fragrance does not affect the release of the oil from the composition. Yet a further advantage is that a very stable injection molding process is obtained, which means that no large fluctuations in process conditions occur and that the quality of the produced parts does not show large deviations.

### Thermoplastic Polyester

Thermoplastic polyesters suitable for the polymer composition of the high-heat delivery device or part thereof may be derived from at least one aromatic dicarboxylic acid or an ester-forming derivative thereof and at least one aliphatic, cycloaliphatic or aromatic diol. Examples of suitable aromatic dicarboxylic acids include terephthalic acid, isophthalic acid, naphthalene dicarboxylic acid, biphenyl dicarboxylic acid, etc., with terephthalic acid being preferred. Suitable diols include alkylane diols, benzene diol, dihydroxyphenyl, naphthalene diol. Alkane diols, like ethylene glycol, propylene glycol, 1,4-butane diol, neopentyl glycol, and cyclohexane dimethanol are preferred. These semi-crystalline polyesters may further comprise small amounts of, for example, aliphatic dicarboxylic acids, monofunctional alcohols and/or carboxylic acids and three or higher functional alcohols and/or carboxylic acids, provided that these polyesters remain melt-processable. Preferably, the content of other monomers in these polyesters is below 20 wt. %, more preferably below 10 wt. %, even more preferably below 5 wt. %, relative to the total weight of the polyester, to ensure the semi-crystallinity of the polyester.

Suitable thermoplastic polyesters that may be used in the polymer composition of the high heat delivery devise or part thereof are, for example, polyalkyleneterephthalates, polyalkylene naphthalates, and polyalkylene bisbenzoates and any copolymers and any mixtures thereof. These polyesters can be derived from alkane diols and, respectively terephthalic acid, naphthalene dicarboxylic acid and 4,4′-diphenyldicarboxylic acid. Suitably, the polyalkyleneterephthalate is poly(1,4-cyclohexane-dimethylene terephthalate) (PCT) or a poly(alkylene terephthalate) based on an aliphatic diol with 2 to 6 carbon atoms, like polyethyleneterephthalate (PET), polytrimethyleneterephthalate (PTT), and poly(1,4-butylene terephthalate) or simply called polybutylene terephthalate (PBT). Suitable poly(alkylene naphthalate)s include polyethylenenaphthalate (PEN) and polybutylenenaphthalate (PBN). Suitable polyalkylene bisbenzoates include polyethylenebisbenzoate (PEBB) and polybutylenebisbenzoate (PBBB). Suitably, these semi-aromatic thermoplastic polyesters comprise a minority content of another dicarboxylic acid or diol. Of these polyesters, PET and PBT, and any mixture or copolymer thereof are preferred. More preferably the thermoplastic polyester is PET.

### First Thermoplastic Copolyester Elastomer

The polymer composition preferably comprises a thermoplastic copolyester elastomer.

Examples of copolyester elastomers include a copolyesterester elastomer, a copolycarbonateester elastomer or a copolyetherester elastomer; i.e. a copolyester block copolymer with soft segments derived from a polyester, a polycarbonate or, respectively, a polyether. Copolyester elastomers are available, for example, under the trade name Arnitel, from DSM Engineering Plastics B.V., The Netherlands.

Suitable copolyesterester elastomers are described, for example, in EP-0102115-B1.

Copolyetherester elastomers have soft segments derived from at least one polyalkylene oxide glycol. Copolyetherester elastomers and the preparation and properties thereof are in the art and for example described in detail in Thermoplastic Elastomers, 2nd Ed., Chapter 8, Carl Hanser Verlag (1996) ISBN 1-56990-205-4, Handbook of Thermoplastics, Ed. O. Otabisi, Chapter 17, Marcel Dekker Inc., New York 1997, ISBN 0-8247-9797-3, and the Encyclopaedia of Polymer Science and Engineering, Vol. 12, pp. 75-117 (1988), John Wiley and Sons, and the references mentioned therein.

The aromatic dicarboxylic acid in the hard segments of the polyetherester elastomer suitably is selected from the group consisting of terephthalic acid, isophthalic acid, phthalic acid, 2,6-naphthalenedicarboxylic acid and 4,4-diphenyldicarboxylic acid, and mixtures thereof. Preferably, the aromatic dicarboxylic acid comprises terephthalic acid, more preferably consists for at least 50 mole %, still more preferably at least 90 mole %, or even fully consists of terephthalic acid, relative to the total molar amount of dicarboxylic acid.

The alkylene diol in the hard segments of the polyetherester elastomer suitably is selected from the group consisting of ethylene glycol, propylene glycol, butylene glycol, 1,2-hexane diol, 1,6-hexamethylene diol, 1,4-butane diol, benzene dimethanol, cyclohexane diol, cyclohexane dimethanol, and mixtures thereof. Preferably, the alkylene diol comprises ethylene glycol and/or 1,4 butane diol, more preferably consists for at least 50 mole %, still more preferably at least 90 mole %, or even fully consists of ethylene glycol and/or 1,4 butane diol, relative to the total molar amount of alkylene diol.

The hard segments of the polyetherester elastomer most preferably comprise or even consist of polybutylene terephthalate segments.

Suitably, the polyalkylene oxide glycol is a homopolymer or copolymer on the basis of oxiranes, oxetanes and/or oxolanes. Examples of suitable oxiranes, where upon the polyalkylene oxide glycol may be based, are ethylene oxide and propylene oxide. The corresponding polyalkylene oxide glycol homopolymers are known by the names polyethylene glycol, polyethylene oxide, or polyethylene oxide glycol (also abbreviated as PEG or PEO), and polypropylene glycol, polypropylene oxide or polypropylene oxide glycol (also abbreviated as PPG or PPO), respectively. An example of a suitable oxetane, where upon the polyalkylene oxide glycol may be based, is 1,3-propanediol. The corresponding polyalkylene oxide glycol homopolymer is known by the name of poly(trimethylene)glycol. An example of a suitable oxolane, where upon the polyalkylene oxide glycol may be based, is tetrahydrofuran. The corresponding polyalkylene oxide glycol homopolymer is known by the name of poly(tretramethylene)glycol (PTMG) or polytetrahydrofuran (PTHF). The polyalkylene oxide glycol copolymer can be random copolymers, block copolymers or mixed structures thereof. Suitable copolymers are, for example, ethylene oxide/propylene oxide block-copolymers, (or EO/PO block copolymer), in particular ethylene-oxide-terminated polypropylene oxide glycol.

The polyalkylene oxide can also be based on the etherification product of alkylene diols or mixtures of alkylene diols or low molecular weight poly alkylene oxide glycol or mixtures of the aforementioned glycols.

Good results are obtained if the polyalkylene oxide glycol is selected from the group consisting of polypropylene oxide glycol homopolymers (PPG), ethylene oxide/polypropylene oxide block-copolymers (EO/PO block copolymer) and poly(tretramethylene)glycol (PTMG), and mixtures thereof.

Also good results are obtained with thermoplastic elastomers containing monomer units of dimerised fatty acids and/or a diamine derived there from. A very strong adhesion is obtained and also a high resistance against fatty acids.

Such dimerised fatty acids may be obtained by the dimerisation of a monomeric unsaturated fatty acid and are indicated by dimerised fatty acid.

After the dimerisation reaction the so obtained oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acid is saturated.

The dimerised fatty acids preferably contain from 32 up to 44 carbon atoms. Most preferably the dimerised fatty acid contains 36 carbon atoms. The amount of C-atoms normally is an average value, since the dimerised fatty acids normally are commercially available as a mixture.

It is also possible to produce a derivative of the dimerised fatty acid by replacing one or two of the acid groups by an amine group by one of the well known reactions.

Preferably the thermoplastic elastomer contains 40-80 wt. % of polybutylene terephthalate hard segments.

### The Second Thermoplastic Copolyester Elastomer

The second thermoplastic copolyester elastomer, it is the second thermoplastic copolyester elastomer of the masterbatch, may be the different or may be the same as the first thermoplastic copolyester elastomer.

Preferably the second thermoplastic copolyester elastomer has a melting point of between 150 and 180° C., more preferably of between 155 and 175° C., even more preferably of between 160 and 170° C. This is because this even further reduces the degradation of the fragrance during the process according to the invention. The melting point being measured by DSC, according to ISO 11357-1/3 (2011), further defined in the examples.

The melting point of the thermoplastic copolyester elastomer may be lowered by choosing a higher amount of soft blocks, a lower molecular weight of soft blocks and especially by using introducing a third monomer in the polyester hard block, preferably iso-phthalic acid.

It is possible to use soft blocks derived from (polyeyhylene oxide-polypropylene oxyde-polyetheylene oxide)glycol or dimerised fatty acid as soft block. Preferably soft blocks derived from poly(tretramethylene)glycol are used.

A fragrance is something (as a perfume) compounded to give off a sweet, delicate or otherwise pleasant odor, such as for example fresh flowers, pine trees etc.)

It is also possible that an oil has the function of a fragrance. The traditional classification of fragrances comprises the following categories:
Single Floral: Fragrances that are dominated by a scent from one particular flower; in French called a soliflore.
Floral Bouquet: Containing the combination of several flowers in a scent.
Ambery: A large fragrance class featuring the scents of vanilla and animal scents together with flowers and woods. Can be enhanced by camphorous oils and incense resins.
Woody: Fragrances that are dominated by woody scents, typically of sandalwood and cedar. Patchouli, with its camphoraceous smell, is commonly found in these perfumes.
Leather: A family of fragrances which features the scents of honey, tobacco, wood and wood tars in its middle or base notes and a scent that alludes to leather.
Chypre: Meaning cyprus in French, this includes fragrances built on a similar accord consisting of bergamot, oakmoss, patchouli, and labdanum. This family of fragrances is named after a perfume by Francois Coty. Pronounced: sheep-ra
Fougère: Meaning fern in French, built on a base of lavedner, coumarin, and oakmoss. Many men's fragrances belong to this family of fragrances, which is characterized by its sharp herbaceous and woody scent. Pronounced: foozh-air

It is possible that more than one fragrance is used.

The master batch preferably comprises less than 35 wt. %, more preferably less than 30 wt. % preferably less than 25 wt. % of fragrance. The master batch preferably comprises more than 4 wt. %, more preferably more than 7 wt. % of fragrance.

The polymer composition used for producing the high-heat delivery device or the part thereof may contain further additives, for instance oils, vitamins, mold release agents and glass fibers. The polymer composition preferably contains 5-30 wt % of a filler material having a heat conductivity that is higher than the heat conductivity of the matrix of the polymer composition, for instance metal particles, carbon black and expanded graphite. Such compositions are for example disclosed in WO2015/028632.

The further components for the final polymer composition of the high-heat delivery device or the part thereof are preferably added in the first polymer composition.

The master batch may be produced by feeding the thermoplastic copolyester elastomer and eventually further additives to an extruder, melting the thermoplastic copolyester and injecting the fragrance into the so obtained melt, cooling down the melt and granulating the master batch. As extruder a single screw extruder or a co-rotating twin-screw extruder may be used. Best results are obtained if an underwater granulator is used. The extruder for producing the first polymer composition may likewise be a single screw extruder or a co-rotating twin screw extruder. The first polymer composition is preferably granulated before, during or after the cooling down. Good results are obtained if an underwater granulator has been used. The first polymer composition and the master batch may be fed to the feed opening of the injection molding machine as separate product streams or as a dry blend. The invention also relates to a high heat delivery device obtainable with the process according to the present invention.

The high-heat delivery device is preferably a part of a hair straightening machine or a hair curler. The high heat delivery device is the part of the equipment that is heated and that is in contact with the hair, when the hair straightening machine or the hair curler is being used. The high-heat delivery device is normally mounted on heating elements or heating plates transferring their heat to the high-heat delivery device.

Preferably the high-heat delivery device is replaceable, more preferably without the use of tools, for example by snap connections.

When the high-heat delivery device comprises a part comprising the fragrance, preferably only the part comprises the fragrance.

The invention is illustrated by the following figures.

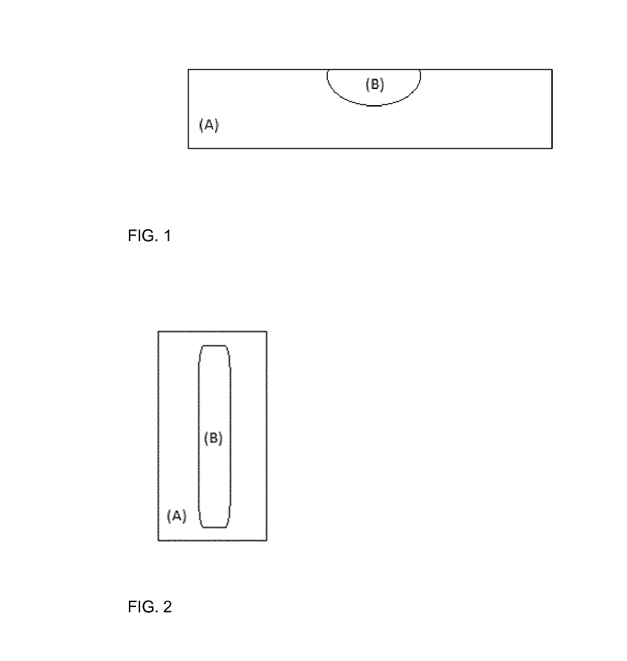

FIG. 1: high-heat delivery device ((A)+(B)) in schematic transverse view, comprising a part (B) being produced according to the process of the present invention.

FIG. 2: high-heat delivery device of FIG. 1, but now in schematic top view.

The high heat delivery device comprising the part (A) and (B) may be produced by over-molding or by two-K injection molding.

The invention is further illustrated by examples and comparative experiments.

### Materials Used

Amite® BAGA 5018 of DSM, polyethyleneterephthalate, Tm=254° C., delivered by DSM.
PBT-Eco=polybutyleneterephthalate-co-dimerfattyacid 20% dimer fatty acid of DSM, Tm=210° C.
Arnitel®3106, block copolymer, comprising hard blocks polybutylene terephthalate, comprising isothalate comonomers and soft blocks of polyehtelene oxide-polpropylene oxide-polyethylene oxide, Tm=165° C., delivered by DSM.
Akulon S222, PA6,6, delivered by DSM the Netherlands.
Oil: a mixture of natural and synthetic oils.
Floral rose 194, a fragrance.
Masterbatch Floral Rose™ 5222603, comprising 80 wt. % polyethylene and 20 wt. % Floral rose 194.

### Measurements

### DSC Melting Point of the Thermoplastic Copolyester Elastomer.

The melting temperature Tm is the peak temperature of the endothermic melting peak measured in step [5] by DSC by the method according to ISO 11357-1/3 (2011) with a scan rate of 10° C./min, which includes the following steps: A sample is first heated in a conventional differential scanning calorimeter (DSC) with a heating rate of 10° C./min in which a first melting temperature [Tm1] is defined, herein understood as the peak temperature of the highest endothermic melting peak. The instrument is purged with dry nitrogen gas with a purge flow 50 ml/min. In order to measure the melting temperature of the polyester, Tm, the following standard temperature program is applied:

[1] Heat from 20° C. to Tm1+20° C. at a scan rate of 10° C./min; purge gas N2 50 ml/min
[2] Keep at Tm1+20° C. for 3 min; purge gas N2 50 ml/min
[3] Cool from Tm1+20° C. to 20° C. at a scan rate of 10° C./min; purge gas N2 50 ml/min
[4] Keep at 20° C. for 5 min; purge gas N2 50 ml/min
[5] Heat from 20° C. to Tm1+20° C. at a scan rate of 10° C./min; purge gas N2 50 ml/min.

The melting temperature Tm is defined as the peak temperature of the endothermic melting peak measured in step [5] by DSC by the method according to ISO 11357-1/3 (2011) with a scan rate of 10° C./min.

### Overmolding Process Stability

During the overmolding of parts(B) the injection pressure was measured of several successive shots. The fluctuations in the injection pressure is taken as a measure of the overmolding stability of part (B).
Very good: hardly any difference in pressure.
Good: small fluctuations, but parts of equal quality are obtained.
Not good: fluctuations to large.
   Odour Duration: Amount of Cycles that High-Heat Delivery Devise can be Used

The high-heat delivery devices were pushed at each other by closing the hair ironing machine. In this way the machine was kept for 10 minutes at 220° C. After that an expert smelled the odour of the fragrance. This was repeated until the expert decided that the odour has become too weak. The result is indicated in amount of times that the device could be used.

### Oil Release

A protein Saver Card (width 25 mm), Whatman™ GE Healthcare Bio-science corp. was placed between a pair of heat delivery devices in a hair straightener and kept in that position for 10 minutes at 200° C. The amount of oil that was sucked into the protein saver card was determined.

### Preparation of the First Polymer Composition

80 parts by weight of Amite® BAGA 5018 and 20 parts by weight of PBT-Eco were fed to a feed opening of a twin screw extruder ZSK30/44D and were molten and mixed in the extruder. An oil mixture was injected in the melting zone. The hot polymer composition string was cooled in a water bath or cooling belt and cut into granules suitable for injection molding.

### Preparation of the Masterbatch

Masterbatch was produced by feeding granulate of Arnitel 3106 to the extruder Berstorff ZE25/52 R. Fragrance is introduced via liquid dosing equipment into the mixing zone of the extruder. The output was 10 kg/hr. The extruder was provided with underwater granulator. The following master batches were prepared:
Masterbatch 1: 90 wt % Arnitel 3106/10 wt % Floral Rose 194
Masterbatch 2: 80 wt % Arnitel 3106/20 wt % Floral Rose 194

### Injection Mouding of the High Heat Delivery Device

Parts (A) were injection molded from Akulon S222 using an Arburg® Allround injection molding machine. The size of parts (A) was about 90×25×2 mm. Thereafter the parts (A) were placed in a mold of the same injection molding machine and parts (B) were produced in the opening of part (A) by overmolding. The size of part (B) is about 75×5×0.7 mm.

### EXAMPLE 1

Part (A) was produced as described above. Part (B) was produced by feeding 4 wt % of Masterbatch 1 and 96 wt. % of the first polymer composition to the feed opening of the Arburg injection molding machine.

The so obtained high heating device was placed on a hair straightening device and tested. The results are given in table. 1.

### EXAMPLE 2

As example 1, but 6 wt. % of Masterbatch 1 was used. For the results see table 1 and 2.

### EXAMPLE 3

As example 1, but 3 wt. % of Masterbatch 2 was used.

### COMPARATIVE EXPERIMENT A

No masterbatch was used, but 0.4 wt. % of the fragrance Floral Rose 194 was directed dosed with the further components in the feed opening of the extruder during the production of the first polymer composition. The results are given in table 1.

### COMPARATIVE EXPERIMENT B

As comparative experiment A, however the fragrance was injected in the melting zone of the injection molding machine. The results are given in table 1.

### COMPARATIVE EXPERIMENT C

As example 1, however no masterbatch or fragrance in any other way was used. The results are given in table 2.

### COMPARATIVE EXAMPLE D

As example 1, however 1 wt % of Masterbatch Floral Rose 5222603 was used. The results are given in tables 1 and 2.

### COMPARATIVE E

As comparative experiment D, however 2 wt. % of the Masterbatch Floral Rose 5222603 was used. The results are given in table 2.

TABLE 1

| | Exam- | Exam- | Exam- | Comp. | Comp. | Comp. |
|---|---|---|---|---|---|---|
| Fragrance | ple 1 | ple 2 | ple 3 | exp. A | exp. B | exp. D |
| Type of | Master | Master | Master | liquid | liquid | granular |
| dosing | batch | batch | batch | | | |
| Floral rose | 0.4 | 0.6 | 0.6 | 0.4 | 0.4 | 0.2 |
| conc. | | | | | | |
| [wt. %] | | | | | | |
| Tests | | | | | | |
| Overmoldi | Very | Very | Very | N.A. | Good | Not good. |
| process | good | good | good | | | |
| stability | | | | | | |
| Odour | 6 | 7 | 7-8 | N.A. | 6 | 3-4 |
| duration | | | | | | |
| (times) | | | | | | |
| Odour initial | OK | OK | OK | Not OK | OK | OK |
| Oil release | OK | OK | OK | NA | | Not OK |
| from part B | | | | | | |

N.A. = not analysed

TABLE 2
Oil release

| | Concentration of | |
|---|---|---|
| | fragrance additive | Oil release |
| Sample | [wt %] | [mg/sleeve pair] |
| Comp. Exp. C | 0 | 0.45 |
| Example 2 | 0.6 | 0.27 |
| Comp. Exp. D | 0.2 | 0.27 |
| Comp. exp. E | 0.4 | 0.20 |

For a the good odour performance (intensity/duration) optimal fragrance concentration has turned out to be 0.4-0.6%. From table 2 it is clear that the oil release is reduced when fragrance is used in the polymer composition. However for comparative experiments D and E this reduction is much more significant than for example 2 according to the invention.

1. A process for producing a heat delivery device containing or consisting of a polymer composition comprising a fragrance or part thereof comprising the steps of:
a) producing a first polymer composition, by feeding a thermoplastic polyester, optionally a first thermoplastic copolyester elastomer and optionally further components of the composition to an extruder, melting and mixing the components of the polymer composition,
b) cooling down the first polymer composition and
c) feeding the first polymer composition and a master batch comprising a second thermoplastic copolyester elastomer and the fragrance to an injection molding machine, melting and mixing the first polymer composition and the master batch in the injection molding machine to obtain the second polymer composition and injection molding of the so obtained molten second polymer composition into the mold of the high-heat delivery device or the part thereof.

2. Process according to claim 1, wherein the thermoplastic polyester is polyethylene terephthalate.

3. Process according to claim 1, wherein the second thermoplastic copolyester elastomer has a melting point of between 150 and 180° C.

4. Process according to claim 1, wherein the second thermoplastic copolyester elastomer has a melting point of between 155 and 175° C.

5. Process according to claim 3, wherein the thermoplastic copolyester elastomer comprises a third monomer in the polyester hard block.

6. Process according to claim 5, wherein the third monomer is iso-phthalic acid.

7. Process according to claim 1, wherein the process comprises the step b1) granulating the first polymer composition before, during or after cooling down.

8. High heat delivery device or part thereof obtainable with the process according to claim 1.
